(19) United States
(12) Patent Application Publication
(10) Pub. No.: US 2002/0127975 A1
(43) Pub. Date: Sep. 12, 2002

(54) Cover for portable phone

(76) Inventor: Gimmy Hsu, Chong Ho City (TW)

Correspondence Address: Gimmy Hsu, P.O. Box 10-69, Chong Ho, Taipei, 235, TW

(21) Appl. No.: 09/803,470

(22) Filed: Mar. 9, 2001

(51) Int. Cl. H04B 1/38

(52) U.S. Cl. 455/90; 455/117; 455/128; 455/348; 455/349; 455/351; 455/300

(57) ABSTRACT

A portable phone includes a front portion, and a cover made of titanium material and detachably engaged onto the front portion of the portable phone for shielding the electromagnetic waves generated by the portable phone. The cover includes a latch or one or more sockets or one or more catches for engaging with the latch opening or the lock studs or the lock notches of the portable phone and for detachably securing the cover to the portable phone. The cover includes a number of orifices and a window for aligning the dial buttons and the displayer of the portable phone.

### BACKGROUND OF THE INVENTION

1. Field of the Invention

The present invention relates to a portable phone, and more particularly to a cover or a housing for the portable phone.

2. Description of the Prior Art

Typical portable phones comprise a cover made of plastic materials which may not be used for shielding the electromagnetic wave and which may include a porous structure formed therein. The other covers are made of magnesic materials which also may not be used for shielding the electromagnetic wave and which may also include a porous structure formed therein that may form an uneven or coarse outer peripheral surface to the portable phone.

Many reports have shown that the electromagnetic waves generated by the mobile phones or the portable phones may hurt or damage the deoxyribonucleic acid (DNA), or the chromosome of people, and may expedite the split of the cells. Particularly when the portable phone is initialized, the strength of the electromagnetic wave may reach as high as 2000 Gausses and may penetrate into or through the muscles or even the skull of the people, and may thus damage the nerves or the brain of the people. Cataract and the other eye diseases, and disorder of memory, and even cancer may be occurred in the users of the portable phones.

The present invention has arisen to mitigate and/or obviate the afore-described disadvantages of the conventional portable phone covers.

### SUMMARY OF THE INVENTION

The primary objective of the present invention is to provide a cover for a portable phone having a characteristic for shielding the electromagnetic wave and for preventing the electromagnetic wave from hurting the users.

The other objective of the present invention is to provide a cover for a portable phone having a smooth outer appearance and having no porous structure formed therein.

In accordance with one aspect of the invention, there is provided a portable phone comprising a portable phone body including a front portion, a cover made of titanium material for engaging onto the front portion of the portable phone body and for shielding electromagnetic waves generated by the portable phone body, and means for detachably securing the cover onto the front portion of the portable phone body.

The detachably securing means includes a latch opening formed in the portable phone body, and a latch provided on the cover for engaging with the latch opening of the portable phone body and for attaching onto the portable phone body. The latch may be adhered to the cover.

The detachably securing means includes at least one lock stud provided in the portable phone body, and at least one socket provided on the cover for engaging with the lock stud of the portable phone body and for attaching onto the portable phone body and includes means for adhering the socket to the cover.

The detachably securing means includes at least one lock notch formed in the portable phone body, and at least one catch provided on the cover for engaging with the lock notch of the portable phone body and for attaching onto the portable phone body and includes means for adhering the catch to the cover.

The portable phone body includes a plurality of dial buttons and a displayer provided thereon, the cover includes a plurality of orifices and a window formed therein and aligned with the dial buttons and the displayer of the portable phone body respectively.

The portable phone body includes a plurality of projections provided on the front portion thereof, the cover includes a plurality of projections provided thereon and engaged with and adhered and secured to the projections of the portable phone body respectively.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a front perspective view of a portable phone having a cover in accordance with the present invention;

FIG. 2 is an exploded view showing the separation of the cover from the portable phone body;

FIG. 3 is a rear perspective view of the cover;

FIG. 4 is an exploded view of the cover; and

FIG. 5 is a cross sectional view taken along lines 5-5 of FIG. 3.

### DETAILED DESCRIPTION OF THE PREFERRED EMBODIMENT

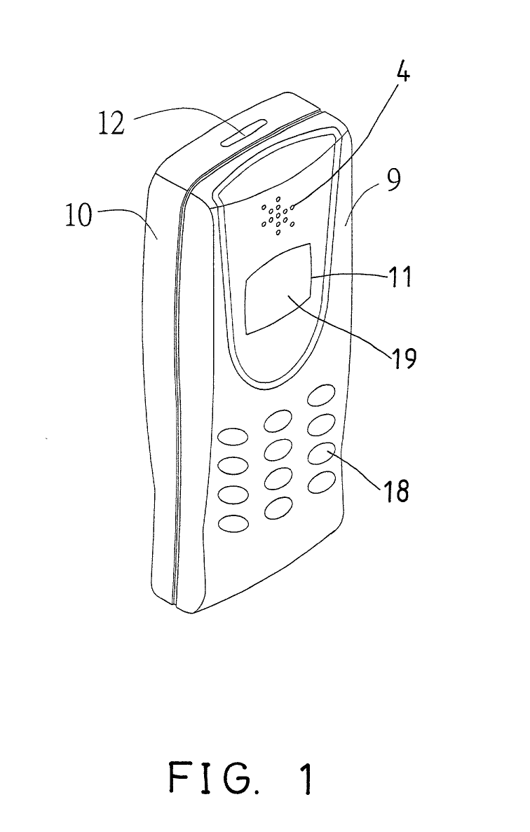

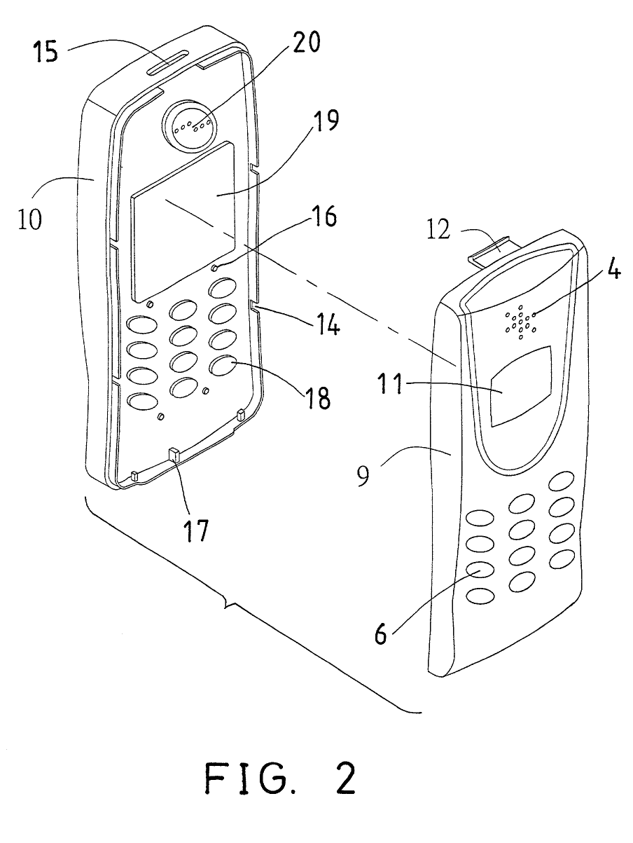

Referring to the drawings, and initially to FIGS. 1-3, a mobile phone or a portable phone in accordance with the present invention includes a portable phone body 10, and a cover 9 for detachably attached or secured onto the portable phone body 10. As best shown in FIG. 2, the portable phone body 10 includes a front portion having one or more seats 17 formed or provided on the bottom portion thereof, and having a latch opening 15 formed in the upper portion thereof.

The cover 9 is preferably made of titanium material that may be forged and machined to form a smooth outer surface and having no porous structure or air holes formed therein. The cover 9 includes a number of orifices 6 and a window 11 formed therein for receiving the dial buttons 18 of the portable phone body 10 and for aligning with the displayer 19 of the portable phone body 10 respectively and for allowing the displayer 19 to be seen through the window 11 of the cover 9. The cover 9 further includes a number of apertures 4 formed therein and aligned with the ear phone 20 of the portable phone body 10 for allowing the sounds generated by the ear phone 20 to be heard through the apertures 20 of the cover 9.

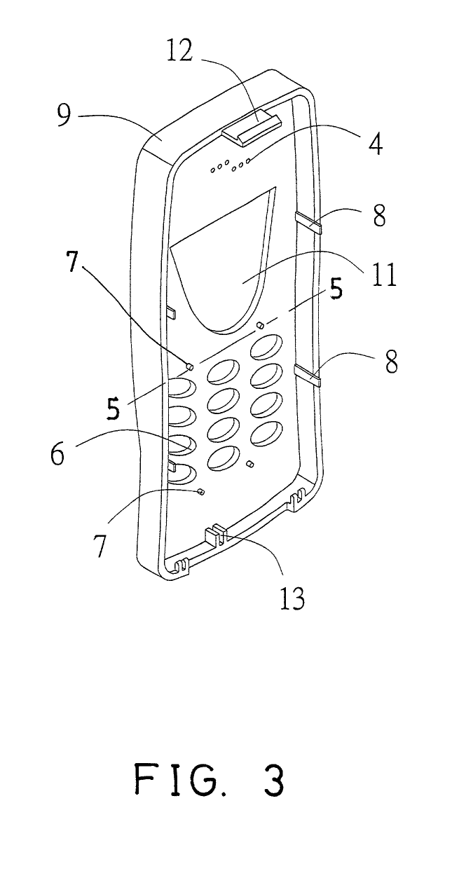

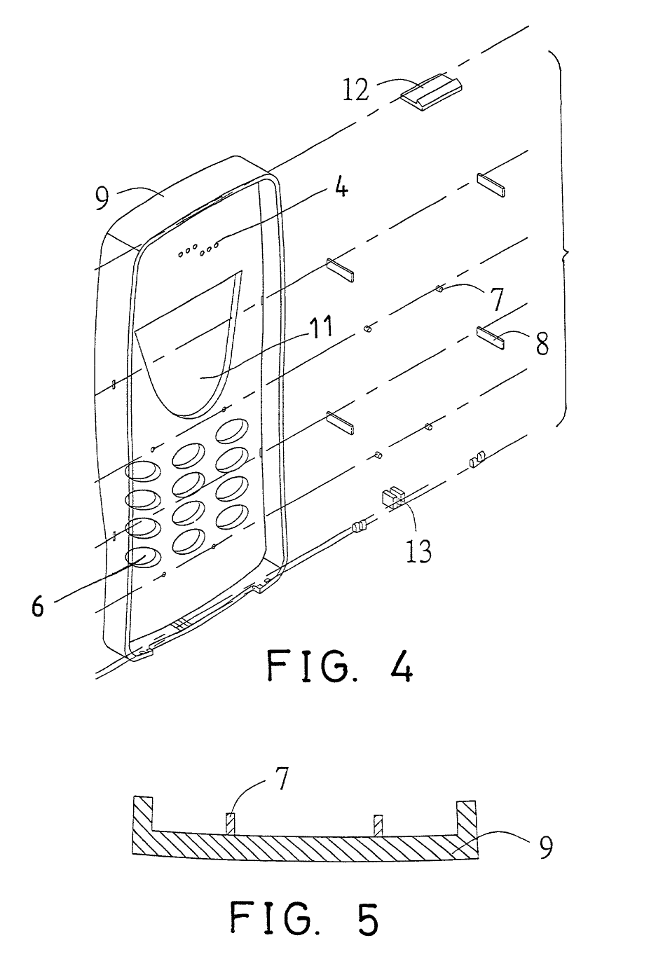

As shown in FIGS. 3-5, one or more projections 7 and/or one or more catches 8 and/or a latch 12 and/or one or more seats or sockets 13 are extended therefrom or secured to the cover 9 with such as the adhesive materials or by welding processes, and are preferably made of the other materials other than titanium material, such as the plastic materials. The catches 8 of the cover 9 may be engaged into the lock notches 14 of the portable phone body 10; and the seats or the sockets 13 of the cover 9 may be used for engaging with or for receiving the lock studs 17 of the portable phone body 10; and the latch 12 of the cover 9 may be engaged into the latch opening 15 of the portable phone body 10, such that the cover 9 may be detachably hooked or secured or attached onto the front portion of the portable phone body 10. The projections 7 of the cover 9 may be engaged with or secured to the projections 16 of the portable phone body 10 with such as the adhesive materials, for further positioning and securing the cover 9 onto the portable phone body 10.

It is to be noted that the cover 9 is made of titanium material and is engaged onto the front portion of the portable phone body 10 and may be used for shielding the electromagnetic waves generated by the portable phones and for preventing the electromagnetic waves from hurting the users and may be formed into a smooth outer appearance having no porous structure formed therein. The cover 9 that is made of titanium material includes a suitable strength for preventing the cover 9 from being easily broken or damaged. In addition, the cover 9 may be easily and quickly and detachably secured onto the portable phone body 10 with the latch 12.

Accordingly, the portable phone in accordance with the present invention includes a cover that may be used for shielding the electromagnetic wave and for preventing the electromagnetic wave from hurting the users and that includes a smooth outer appearance having no porous structure formed therein.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A portable phone comprising:
a portable phone body including a front portion,
a cover made of titanium material for engaging onto said front portion of said portable phone body and for shielding electromagnetic waves generated by said portable phone body, and
means for detachably securing said cover onto said front portion of said portable phone body.

2. The portable phone according to claim 1, wherein said detachably securing means includes a latch opening formed in said portable phone body, and a latch provided on said cover for engaging with said latch opening of said portable phone body and for attaching onto the portable phone body.

3. The portable phone according to claim 2, wherein said detachably securing means includes means for adhering said latch to said cover.

4. The portable phone according to claim 1, wherein said detachably securing means includes at least one lock stud provided in said portable phone body, and at least one socket provided on said cover for engaging with said at least one lock stud of said portable phone body and for attaching onto the portable phone body.

5. The portable phone according to claim 4, wherein said detachably securing means includes means for adhering said at least one socket to said cover.

6. The portable phone according to claim 1, wherein said detachably securing means includes at least one lock notch formed in said portable phone body, and at least one catch provided on said cover for engaging with said at least one lock notch of said portable phone body and for attaching onto the portable phone body.

7. The portable phone according to claim 6, wherein said detachably securing means includes means for adhering said at least one catch to said cover.

8. The portable phone according to claim 1, wherein said portable phone body includes a plurality of dial buttons and a displayer provided thereon, said cover includes a plurality of orifices and a window formed therein and aligned with said dial buttons and said displayer of said portable phone body respectively.

9. The portable phone according to claim 1, wherein said portable phone body includes a plurality of projections provided on said front portion thereof, said cover includes a plurality of projections provided thereon and engaged with and adhered and secured to said projections of said portable phone body respectively.
